(19) United States
(12) Patent Application Publication
(10) Pub. No.: US 2025/0163848 A1
(43) Pub. Date: May 22, 2025

(54) Eco Barrier System

(71) Applicant: Gary Ross, Redcliffe (AU)

(72) Inventor: Gary Ross, Redcliffe (AU)

(21) Appl. No.: 18/953,839

(22) Filed: Nov. 20, 2024

(30) Foreign Application Priority Data
Nov. 22, 2023 (AU) 2023270282

(51) Int. Cl. F02C 3/22; F01K 23/10

(52) U.S. Cl. CPC F02C 3/22; F01K 23/10; F05D 2220/72

(57) ABSTRACT

An Eco Barrier System inclusive of Green Technology.

### CROSS REFERENCE TO RELATED APPLICATION

This application claims priority to Australian Application No. 2023270282 filed on Nov. 22, 2023, the disclosure of which is incorporated herein by reference for all purposes.

### FIELD OF THE INVENTION

Green Technology: This application contains one or more claims to a product or process that mitigates climate change by being designed to reduce and/or prevent additional greenhouse gas emissions.

### BACKGROUND OF THE INVENTION

Father, some have a perception of climate change like a safety drill, complacent, as if it will not affect them. For others, technology cost is prohibitive versus perceived benefit, so it's business as normal and accept the consequences.

They have been looking in the wrong place for answers, share with your decision makers an appreciation of ECO Barriers and place in their hearts a trigger to do the right thing, right now and to protected for their bold steps. Amen

### Patent Intent

Teaching of technical advances in the Art to expand human knowledge and not reinvent the wheel. This patent application is written with minimum legalize in a report style, inclusive of both technical and non-technical background to bring an understanding for the layperson.

### Inventive Concept: Motivation

Top contributor to “The Climate Change Problem”, is power generation from fossil fuel sources at 39% of global anthropogenic emissions which was addressed by U.S. application Ser. No. 16/635,088 referenced herein as the “State of the Art”: a ‘carbon neutral’ solution for base load power generation using a fossil fuel source.

Globally, cities take up to 80% of the world's energy consumption and 75% of carbon emissions. To maintain a nation's comparative advantage during peace and war they require security of supply to sustain economic success, an issue for weather dependent generation which are vulnerable to climate change impacts.

The ‘New Problem’ is a potential failure of ECO Barriers with Loss of Containment (LoC), and an abrupt natural release of Green House Gases (GHG). If the problem to be solved is novel and inconceivable by a person skilled in the art, this may be a factor in support of the existence of an inventive step.

Herein, my inventive step is the way of solving the ‘New Problem’ and my inventive step is that solution, a ‘System’ to mitigate the cause of ECO Barriers potential Loss of Containment (LoC) event, defined using industry terminology as a Floating Climate Neutral Generation System or ‘CNG’. The method of the solution is to first prioritize the areas of highest consumption, said coastal cities with a dispatchable Generation System providing Security of Supply in order to foremost mitigate failure of said ECO Barriers, while it is still feasible, i.e., ASAP.

Climate neutral refers to the emission and mitigation of all greenhouse gases, not just carbon. The design and description for State of the Art technology was for carbon neutral only, a subsequent technical limitation at time of filing.

For context only, not a patentability requirement but a solution to said problem requirement is a need for like-for-like capacity replacement for anthropogenic emission power stations or retiring nuclear power stations, this necessitates operational similarities, capabilities of nominal 3.5 GW and base load.

Said CNG, fulfills said capabilities and can sustain base load security of supply operation. Furthermore, as explained herein there is a critical time element, as the system is floating, dictates fast track construction and replication, wherein inherit in the design are capabilities to withstand extreme oceanic weather events.

The EPA advises “extreme weather and natural disasters pose significant risks to the U.S. energy supply in all regions of the country. Where energy systems on both the Gulf and East Coasts face more risk of damage from flooding due to hurricanes and sea level rise”. A critical resource for system restoration and recovery plans for grid operators, are black-start capabilities which CNG can provide. For security of supply to critical infrastructure, the system can operate in Island Mode and export to a microgrid for fueling electric transportation systems.

Furthermore, to support grid resilience in coastal areas with a high penetration of variable renewable generation, the CNG can provide primary grid response by operating at no-load and spinning turbines on compressed air for rapid grid synchronization.

### Inventive Step: Fulfilling a Need

The ‘Need’ is clarified as a technical solution’ to mitigate the ‘New Problem’. Herein, we teach to the layperson, said Problem to be the cause of a potential worst case risk scenario associated with climate change. It is recognized this approach is novel and not available in public or research literature, where there are potential apocalyptic storylines based on tipping points but not an assessed worst case risk scenario. [Simply: a gap in perception of risk versus issue]

The answer to, ‘is that Need Now’ dictates analysis of current mitigation pathways for climate change, versus what is required to mitigate said worst case risk scenario and the critically of intervention timing. This is a strawman approach, a line in the sand, and requires quantitative calculations later. Noted, time is critical: before we pass a ‘point’ of no return where mitigations will become ineffective.

Important is the understanding of risk characterization, so we portray Tipping Points as a safety critical system i.e., ECO Barriers. Laypeople use critical safety systems every day, like fuses to prevent death by electric shock. At this time, there is no representative safety system to prevent death from climate change extreme weather events. You have to teach the person with no skill in the art, so they support the solution. There is no benefit to teach in IPPC legalize to the global world population, the message becomes distorted as more bad news.

The teaching beginneth with IPPC description for Tipping Point as a critical threshold beyond which a system reorganizes often abruptly and/or irreversibly.

The State of the Art is best foretold by a leading Professor of Climate System Dynamics, with a summary from a publicly available webcast:

“There has been talk of abrupt changes in aspects of the earth system climate system like, for example, the Atlantic circulation, for a while, but actually, the first paper that laid down all the possible abrupt changes or tipping points that might occur was this paper by my colleague, Tim Lenton, published in PNAS.

So those tipping points were proposed by Lenton et al. based on paleoclimate evidence and modeling runs from climate models and simple models, but also abrupt change and tipping points have been detected in the climate models that were used in the last IPCC report. You could see it in five models. This is from a paper by Drijfhout I think also in PNAS, showing abrupt changes seen in various models, in the Arctic, and in Amazonia, those tipping points by Tim Lenton.

And so, in the last IPCC report, which I was an author on, we finally got a bit more on tipping points into the report. But actually, there's very little analysis done on abrupt change in complex models, partly because it's difficult and partly because we're always obsessed with climate change and global warming as a function of emissions. It said that there is evidence of abrupt change in Earth's history, and some of these events have been interpreted as tipping points.

I think it's fair to say it's pretty clear they are tipping points, abrupt changes before we start to foster the system. And the probability of low-likelihood, high-impact outcomes, which is another name for tipping points really, increases with high levels of global warming. This is despite the fact that the models seem to show a relatively linear warming with emissions.

There is definitely evidence of abrupt change locally.”

End of Webcast.

A complex ecosystem with many perceptions, of which, this is One; IPPC scenarios are comprehensive economic global system models inclusive of agreed Nationally Determined Contribution pathways. for the purpose of mitigation and unequivocally not a worst case scenario, nor are they intended or portrayed to be.

In Major Accident Risk (MAR) Management, the importance of communication to the decision makers of critical information is essential to enable an informed decision to be made. Either accept the risk and consequences thereof or intervention with appropriate mitigation technologies or prohibit the root cause.

In this instance with no worst case scenario defined, there is simply no risk event for Decision Makers to review, and by default, we inherit the risk outcome. There is no-one at fault, it's just the State of the Art for Climate System Dynamics and what the decision makers of today have inherited. Within industry, low probability, high consequence risks are challenging to recognize and characterize.

Moreover, Earth System Models forecast using State of the Art software and scientific expertise, what can we do to our ecosystem. Unfortunately, there is another side to the ecosystem ‘Coin’: further to anthropogenic forcing, what can the Ecosystem do to us. The potential outcome is told, based on paleoclimate evidence, i.e., historical events, due to no better way of forecasting the unknown.

Furthermore, risk characterization clarifies Tipping Points to be a known issue: subject of continuous research by the scientific community to realize conception of the dynamics, and update of singular tipping elements thereafter, i.e., methane clathrates. There is a 100% probability said Tipping Points will occur, when a temperature threshold is reached, driven by anthropogenic emissions.

An ‘uncertainty’ range is demonstrated for the temperature thresholds which triggers the singular Tipping Points Elements. This patent application is not the place to provide in-depth details of publicly available literature to teach further. It is publicly recognized by the scientific community that ranges for said temperature thresholds are continually being lowered based on updated research and we trust inclusion of real world observations. The system is complex with feedback loops and therein potential for surprises due to system dynamics: Unknown, Unknowns. Notable, said models will be calibrated for accuracy post-event and requirement for intervention is pre-event: a contingency allowance for model error is essential.

FIG. 1 Introduces a ‘bow tie’ visual for a climate change associated risk scenario of the present day. The Risk Event (RE) in the visual center is defined as;

### Potential for Exponential Rise in Earth's Atmospheric Temperature

On the left hand side are causes: The Climate Forcer of Anthropogenic Emissions (AE) with potential future Forcers of Tipping Points (TP), i.e., dash lines to Atmosphere (ATP), Biosphere (BTP), Cryosphere (CTP), Hydrosphere (HTP).

Mitigation barriers, Primary (PMB), Administration (AMB) prevent or minimize risk event or post occurrence Secondary (SMB). On the right hand side are consequences, with least impact bottom, C1, and increasing in severity to C5:
Consequence (C1): Extreme Weather Events/Wildfires, Flooding & Deglaciation,
Consequence (C2): Extreme Weather Events/Droughts, Poverty & Displacement,
Consequence (C3): Continuous Extreme Weather Events/Mass Extinction Event,
Consequence (C4): Global Atmospheric Oxygen subceeds Livable Limits,
Consequence (C5): Global Atmospheric Temperature exceeds Livable Limits.

The teaching continues, an initial observation of said Risk Event and potential consequences C4 and C5 suggest discovery for a ‘worst case scenario’. However, approval process for a risk event dictates to assess probability, and in this instance, the paleoclimate evidence supports we are in a live event: an exponential atmospheric temperature rise occurring and consequence of C1.

In turn, when said tipping points are beached the higher consequences may occur. For an unmitigated reference scenario, the potential consequence for loss of life may be 10 Billion, accounting for event timing. Fortunately, intervention at net zero by Nations signed to Paris Accord, is targeted for mid-century, i.e., 2050.

For Risk Management to be effective, identification of events with the potential for significant loss of life, Major Accident Risk (MAR), dictate a ‘need’ to search and find the present day ‘needle in the haystack’ and mitigate thereof.

To be explicit and using an unfortunate analogue: predicting the sequence of events that foretold the sinking of RMS Titanic. Critical would have been intervention timing, as to mitigate actions would have to be in place before sailing.

However, it is recognized that if a scenario was identified and mitigations were available, intervention may have been frustrated by decision makers and their perception of risk at that time of RMS Titanic being ‘unsinkable’; so why do you need to implement mitigations that interfere with business as normal, plain sailing.

For the worst case risk scenario for climate change, we review the Tipping Point Elements, renamed with a risk perspective as ‘ECO Barrier’ Elements: preventing failure of a safety critical ‘ECO System’, and disastrous consequences.

| # | ECO Barrier Elements | Impact to Safety Critical ECO System |
|---|---|---|
| 1 | Arctic Winter Sea Ice | Meltwater Pulse/Feedback loop |
| 2 | Barents Sea Ice (abrupt loss) | Meltwater Pulse/Feedback loop |
| 3 | Greenland Ice Sheet | Loss of containment/Meltwater Pulse |
| 4 | East Antarctic Ice Sheet | Meltwater Pulse/Feedback loop |
| 5 | West Antarctic Ice Sheet | Meltwater Pulse/Feedback loop |
| 6 | Labrador Irminger Seas Convection | Oceanic Forcer for Feedback Loop |
| 7 | Atlantic M.O. Circulation | Oceanic Forcer for Feedback Loop |
| 8 | Boreal Forrest Dieback | Loss of containment - abrupt release |
| 9 | Amazon Deforestation & Wildfires | Loss of containment - abrupt release |
| 10 | Tundra Permafrost Melt | Loss of containment - abrupt release |
| 11 | Mountain Glaciers (loss) | Meltwater Pulse/Feedback loop |
| 12 | Sahel and W. African Monsson | Atmospheric Forcer in Feedback loop |
| 13 | Unknown, Unknowns | Loss of containment/Feedback loop |

Using the proven methodologies for risk management, we introduce visuals of Barriers and a ‘Swiss Cheese’ model; wherein unpredicted alignment of the holes results in unplanned disastrous consequence. We determine what is known, to identify what is unknown, which requires critique by independent industry experts, in a forum with decision makers present: planned for a later date.

FIG. 2 Introduces a visual for an ECO Barrier System of the present day. ECO Barriers 1 through 13, are in equilibrium with arrows showing feedback loops. Anthropogenic Emissions (AE) caused an Exponential Temperature Rise (ETR) and a subsequent Anthropogenic Forcer (AF) to said ECO Barrier System. ‘Holes’ represent current observations of temperature induced Eco Barrier degradation.

FIG. 3 Introduces a ‘Swiss Cheese’ model of an ECO Barriers System of the present day. Said Barriers, feedback loops and degradation are similar to FIG. 2.

FIG. 4 Is a ‘Swiss Cheese’ model of ECO Barriers System of a future day. Temperature induced degradation of the Eco Barriers System is illustrated in white and feedback loops arrows indicate barrier circumvention. Initial linage of ‘Swiss Cheese’ holes, as per closed loop system dynamics there is cause and effect. Climate Natural Forcers (NF) are now present with this indicated by arrows further distressing the live event in the circle of said Exponential Temperate Rise (ETR).

FIG. 5 Is a visual for an ECO Barrier System, post event shown in FIG. 4. A Systematic Temperature Forcer (STF); the grouping of Anthropogenic Emissions (AE) plus significant Natural Emissions (NE) due to Loss of Containment is driving said Exponential Temperature Rise (ETR) leading to a sequence of cascade events: Stage 1 (S1), Stage 2 (S2), and Stage 3 (S3). Arrows indicate distressing the new event in the circles, Abrupt Temperate Rise (ATR). i.e., a nonlinear temperature rise as per paleoclimate evidence.
Scenario: Year is 2055, AR6 SSP5-8.5 forecasts a global average temp. of 2.5° C.
Stage 1. Ecosystem Containment partial release of GHG due to unfreezing tundra,
Stage 2. Containment partial release of GHG due to large dieback of boreal forest
Stage 3. Containment partial release of GHG deforestation/wildfires In Amazonia Disclaimer: a deterministic assessment requires climate dynamics expert critique.

FIG. 6 Is a ‘Swiss Cheese’ Model post ATR event shown FIG. 5 said Barriers, feedback loops and degradation are similar. Climate Natural Forcers (NF) are in operation with this indicated by arrows distressing the event in the circle, ATR said Abrupt Temperate Rise, now primary driven by ECO Barrier System Loss of Containment in a closed loop system. Therein Nature is now the Climate Driver.

FIG. 7 Is a visual for an ECO Barrier System, post ATR event shown FIG. 6 Cascade Scenario: The sequence of cascade events S1 through S3 result in an attempt to stabilize Abrupt Temperature Rise (ATR) by deploying Solar Radiation Modfication (SRM) on a global scale. This works, for a period, however due to other unknown consequences is terminated, triggering an anthropogenic ATR, and Stage 4: Partial release of GHG due to Greenland Deglaciation & AMOC weakens Stage 5: Peripheral event [Murphy's Law: when it can go wrong, it will go wrong] Consequence: Abrupt GHG, feedback loops extrapolate ‘nature emissions’ (NE) and ATR, with STF triggering a worst case Major Accident Risk (MAR) event, defined as: Potential for ‘triggering’ thermal shutdown of Earth's Ecosystem i.e., per paleoclimate evidence, highs, and lows of global atmospheric temperature.

For the avoidance of any doubt the cumulative effect of all tipping points being triggered is not a risk event, that is a known issue, with uncertainty on time.

A partial ECO Barrier System failure is the initial cause of the MAR risk scenario and thereafter potential for ‘abrupt releases and meltwater pulses’ due to Eco Barrier Degradation: multipipe dynamic forces instead of one big event.

At Natures Temperature Threshold, to prevent system overload, a thermal shutdown event is triggered with stabilization of temperature at Hot House Earth plateau for millennia, then a further unknown threshold is triggered by natural consequences, plateau destabilization and a rapid descend to an ice age. Reloop.

We are sailing into a fog of unknown, unknown's wherein paleoclimate evidence may not be always correct, or we miscalculated an historical event.

Note, an alternative worst case outcome, not represented in paleoclimate: due to abrupt and pulsed climate forcing this may create instability in nature's ecosystem correction during said Thermal Shutdown. Wherein temperature plateau is replaced with oscillation into a rapid temperature descent and ice age.

Disclaimer, a deterministic ‘strawman’ approach to find the ‘needle in the haystack’ for the prodigy vessel ‘RMS Climate Change’: necessitates an AI neural network model calibrated by leading mathematicians of climate system dynamics.

There is NO identical precedent, to fill the knowledge gap, climate scientists utilize paleoclimate evidence to support an analogue but note of uncertainty on the cause of short duration events, which are described as ‘abrupt’; evidence is recorded in the climate of Greenland at the end of the Younger Dryas, as measured by ice-cores, implying a sudden warming of +10° C. (+18° F.) within 1 or 2 decades.

Albeit older, another event which may be used as an analogue for said risk scenario, is the Paleocene-Eocene thermal maximum (PETM). Speculated to have occurred around 55.5 million years ago, this resulted in a 5-8° C. global average temperature rise. PETM literature advises of notable point “a mechanism must have been invoked to produce an instantaneous spike which may have been accentuated or catalyzed by positive feedback or activation of tipping or points.”

IPCC AR6 SYR Section 3.1.3|“Risks associated with large-scale singular events or tipping points, such as ice sheet instability or ecosystem loss from tropical forests, transition to high risk between 1.5° C.-2.5° C. (medium confidence)” and to very high risk between 2.5° C.-4° C. Additional climate forcers are IPPC AR6 p826: “negative synergies between local impacts like deforestation and forest fires may interact with global drivers like climate change and lead to tipping points.”

Our current temperature pathway, is best told by those skilled in the Art, IPPC Working Group III Contribution to the Sixth Assessment Report (AR6): “Where are we heading now? The gap between projected emissions based on Nationally Determined Contributions in 2030 and emissions pathways compatible with the long term temperature goal set in the Paris Agreement remains, large.”

IPPC Future Global Climate: 4.2|“The effects of substantial reductions in carbon dioxide emissions would not be apparent immediately, and the time required to detect the effects would depend on the scale and pace of emissions reductions. Under the lower-emissions scenarios, increase in atmospheric carbon dioxide concentrations would slow visibly after about five to ten years, while the slowing down of global surface warming would be detectable after 20 to 30 years.”

Based on paleoclimate analogues, hypotheses of our ecosystem to be a closed loop system of Eco Barriers, preventing a nature driven abrupt temperature rise which triggers thermal shutdown at Temperature Threshold to prevent ecosystem overload, is a low probability, high consequence risk, as of 2023 AD.

Inventive Step: Is that Need Now [Fulfilling a Need]

The timing of mitigations will be the most important in human history, as hindsight or negotiations will not influence how Nature operates the Ecosystem. To be explicit, collaboration will be a perquisite and to be effective all nations require to participate. A solution is renewables for rural demand and the inventive concept herein for coastal cities to support the 2° C. pathway. Targeting the areas of highest consumption first, on a global scale, for a significant near-term impact.

The term Emergency Generator or Prime Generator is familiar to the layperson for use during weather events and power outages. In simple terms, said invention is an industry emergency generator to mitigate extreme weather events.

The inventive concept herein is fulfilling a need, and that need is now. Intervention, or mitigation based on current interpretation of tipping point thresholds, would dictate to hold firm on a 2° C. pathway, as we need said temperature contingency to account for modelling or data reporting errors.

### To Teach Limitations of the State of the Art:

Background, description, preferred embodiments, and drawings are shown herein: The present invention, in part, utilizes the part that the OCC plays in the overall carbon cycle. It is generally recognized that the ocean is a carbon sink since it takes up more carbon from the atmosphere than it gives out. Thus, carbon dioxide from the atmosphere dissolves in the waters of the ocean.

There are predictions based on mathematical modelling that disposal of C02 into the surface ocean (<1 km depth) would permit equilibration with the atmosphere within a few years to decades and would therefore offer little advantage, but that disposal into ocean basins greater than 3 km in depth would delay equilibration with the atmosphere for several hundred years, eliminating the atmospheric concentration transient.

Referring first to FIG. 8, there is shown a floating structure 10, which can be a barge, platform, or the like, and which can be dynamically or statically positioned at a suitable offshore location. The positioning of structure 10 in deep water can be accomplished using well known methods used in deep water positioning and mooring of drilling and production platforms in the oil and gas industry. Mounted on structure 10 is a gas processing I optimization module 12 which is connected by a conduit 14 to a pipeline 16 laying on the seabed 18. Generally speaking, gas pipeline 16 will be for the transport of light hydrocarbon gases, e.g., natural gas which contains primarily methane. In gas processing module 12, gas transferred from pipeline 16 and line 14 can be treated in various ways well known to those skilled in the art to remove unwanted contaminants, water, and other components that would deleteriously effect downstream operations. Module 12 can also include separation and enrichment systems to optimize BTU content of the gas from pipeline 16.

Also mounted on structure 10 is a power station module shown generally as 20 and which can comprise a driver, e.g., a gas turbine, or steam turbine, both of which are well known to those skilled in the art and both of which, in the present invention, would be powered directly or indirectly from the combustion of a fuel, e.g., processed natural gas transferred via line 24 from processing module 12. The combusted gas (flue gas) generated in the driver or power section 22 of module 20 is sent to a gas collection system comprised of a compression station 26 to compress the flue gas and transfer it to a conduit or line 28 to a subsea location at a desired optimal depth which can be in the sunlit waters of the ocean, but is preferably, for reasons discussed above, in a deeper ocean pool at about 3 km or greater below the ocean surface. In a preferred embodiment, prior to compression in compression station 26, the flue gas is sent to a carbon dioxide separation station 25 wherein the carbon dioxide is separated from the flue gas by absorption, adsorption, membrane gas separation, or other methods well known to those skilled in the art. The carbon dioxide only is then sent to compression station 26 and ultimately transferred to a subsea location by conduit 28. The non-carbon dioxide components of the flue gas are then processed and disposed with by means well known to those skilled in the art.

The turbine comprising driver 22 is mechanically connected in a well-known fashion to an electric power generator 24 whereby electric power is generated and transferred via line 28 to an electric power substation 30. Substation 30 will generally have switching, protection, and control equipment, and transformers, the output from substation 30 being transmitted via electric power transmission line 32 to a remote location, preferably on land where it can be distributed as needed.

Turning now to FIG. 9, there is shown another embodiment of the present invention. The embodiment shown in FIG. 9 is substantially the same as that shown in FIG. 8 with the exception that gas from pipeline 16 is transferred via line 14 to a gas storage tank 15 positioned on structure 10. The gas in storage tank 15 is transferred via line 13 to gas processing module 12. In all other respects, the embodiment of FIG. 8 is the same and functions in the same manner as the embodiment of FIG. 9.

Turning now to FIG. 10, there is shown another embodiment of the present invention which is similar to the embodiments shown in FIGS. 8 and 9, with the exception it employs liquified natural gas (LNG) as a fuel source. To this end, there is a barge or ship 42 which has a compartment or vessel 44 carrying LNG, the LNG being transferred form compartment 44 via line 48 to storage vessels 46 on structure 10. LNG is transferred via line 47 to a regasification module 50 and thereafter regasified liquid natural gas (RLNG) via line 52 to gas processing module 12. Using fuel injection technology, it may be possible for LNG to be used as a fuel, without regasification. In all other respects the embodiment of FIG. 10 is the same and functions in the same manner as the embodiment of FIGS. 8 and 9.

Referring now to FIG. 11, there is shown a schematic layout of a typical gas turbine system that can be used in the power generating system and method of the present invention. The gas turbine system of FIG. 11 comprises a compressor 60, coupled by shaft 62 to a turbine 64. In a well-known manner, air is introduced into compressor 60 via line 66, the air being compressed and then transferred via line 68 to a combustion chamber 70 where it is admixed with a suitable fuel, e.g., natural gas, LNG, the fuel igniting in combustion chamber 70 to generate a high temperature, high pressure gas flow which is introduced via line 74 into turbine 64 to drive turbine 64 wherein it expands down to an exhaust pressure producing a shaft work output via shaft 76 which can then drive an electric power generator, e.g., generator 24. The carbon dioxide combustion gas from turbine 64 is then captured for transfer via line 28 for sequestration at a suitable depth below the surface of ocean as described above with respect to embodiments of FIGS. 8-10.

In the case of a steam turbine, the natural gas would be used to convert water to steam, the steam in turn being used to spin the turbine, the output shaft of the turbine being coupled to an electric generator as in the case of the gas turbine. It is further contemplated there could be combination of gas and steam turbines, similar to configurations on land based combined cycle power stations which are well known to those skilled in the art.

In all of the embodiments discussed above, either natural gas or LNG has been used as a fuel source. However, it is within the scope of the present invention for the fuel source to comprise oil, heating oil and other hydrocarbon liquids. Further, the fuel source could comprise coal which could be transferred by barge from the shore to the offshore structure, the coal forming fuel for a boiler generating steam to drive a steam turbine. While admittedly the use of coal poses greater combustion gas capture problems, there are known technologies for capturing combustion gases from the burning of coal or similar solid fossil fuels, which can trap noxious gases other than C02 and transfer the remaining C02 into the ocean as discussed above with respect to the embodiments shown in FIGS. 8-10. Such a system might be useful where conditions make it difficult to supply the system with natural gas, LNG, or other similar fluid fossil fuels, and wherein the adjacent land is rich in coal deposits. Further, waste paper products could also be used as a fuel source. It is further contemplated that the carbon dioxide collection system may include systems for adding chemical additives, if required, prior to subsea transfer to mitigate potential for localized ocean acidification, due to point source oceanic sequestration of carbon dioxide. As described above, the structure can be a floating structure similar to deepwater oil and gas offshore platforms, or a fixed structure similar to current, relatively shallow water oil and gas platforms, thereby forming a semi-permanent structure. However, the use of some type of floating structure is preferable since it allows the system to be transferred at will from one location to another to optimize cost considerations. It will also be understood that feed stock and electric power or export connections will be of a type that could be quickly disconnected to allow the structure to be moved in the event of weather related events such as hurricanes. It will be further understood that power plant, depending upon what type of turbine(s) are employed can also comprise boilers, steam generators, pumps, and typical equipment used in onshore electric power generating stations and systems as well known to those skilled in the art. It is further contemplated system could also include a separate vessel or structure having electric power storage capabilities. End.

Nomenclature, to teach understanding of technical terminology for the layperson: Dispatchable generation refers to sources of electricity that can be programmed on-demand at the request of power grid operators, according to market needs. Non-dispatchable renewable energy sources such as wind power and solar photovoltaic (PV) power cannot be controlled by grid operators.

Electrolysis is the process for interchange of atoms and ions by the removal or addition of electrons due to the applied current, in a unit called an electrolyzer. CO2 Electrolysis: DC electricity to split CO2 into carbon monoxide (CO) & oxygen to produce value-added chemicals such as methane, ethylene, ethanol. H2O Electrolysis: DC electricity to split water into hydrogen (H2) & oxygen.

Heat Recovery Steam Generator (HRSG): Heat of the gas turbine's exhaust can be high as 450 to 650° C. (723K to 923K) which is used to generate steam by passing it through a heat recovery steam generator with a live steam temperature.

Membrane Separation Technology (MST) has matured as an effective process for the post combustion flue gas separation of CO2, SO2 and NOx. Different membrane materials provide optimum permeability and selectivity based on the operating conditions, and well known to those skilled in the art.

Organic Compounds, the most common elements present are carbon, hydrogen, oxygen, and nitrogen. A hydrocarbon is highly combustible, consisting of hydrogen and carbon which is found in crude oil, natural gas, and coal.

Fischer-Tropsch: A chemical process developed in the 1920s to convert a mixture of carbon monoxide and hydrogen, called synthesis gas or syngas, into hydrocarbon chains of varying lengths, which can used as synthetic fuel.

Solid Oxide Electrolyzer: use a solid ceramic material as the electrolyte. They must operate at temperatures high enough for the solid oxide membranes to function properly (typically 700°−800° C.) i.e., effectively use high temperatures to decrease the amount of electrical energy needed to produce hydrogen from water.

Solid Acid Electrolysis Cell: CO2 feedstock, steam, and cell operation at temperatures in the range 150-250C produces carbon monoxide, methane, methanol, ethane, ethylene, ethanol, acetaldehyde and propylene.

Intermediate Temperature Steam Electrolyzer: Proton-conducting ceramic electrolytes with operation typically in a temperature range of 600° C. to 650° C.

High Temperature Steam Electrolyzer: is a method of electrolysis where steam is dissociated to H2 and O2 at temperatures between 70° and 1000° C. In electrolysis, system efficiencies increase with increasing operating temperatures.

Ultra-High Temperature, Steam Electrolyzer is a method of electrolysis where steam is dissociated to H2 and O2 at temperatures above 1000° C. Manufactured using Ultra High Temperature Ceramics UHTCs composites which conduct energy through material and reradiate it through cooler surfaces. UHTCs provide chemical and structural stability at extremely high operating temperatures.

Ultra-High Temperature Combustion Turbine (UHTCT) manufactured using UHTCs for the turbine bladed leading edge, connected to carbon-based composite and thereafter to the turbine metallic structural elements.

Oxy-Combustion: The technological challenges of oxy fuel combustion are well known to those skilled in Art, resulting in a minimal adaptation of this technology as basically not commercially viable. Therein, to separate the CO2 in the flue gas efficiently, the nitrogen must be removed pre-combustion in order to make the CO2 post-combustion capture process efficient. This process is known to have the following primary disadvantages for oxyfuel combustion which are, very high energy requirements for producing high purity O2, and very high temperatures produced by combustion in a pure oxygen environment. As a result, flue gas must be recycled in large quantity to keep temperatures at reasonable levels.

The Art is focused on hybrids, one is the Allam-Fetvedt Cycle which operates as a recuperated, high-pressure, Brayton cycle employing a trans-critical CO2 working fluid with an oxy-fuel combustion regime. Another is focused on bespoke oxy-fuel turbines, and gas generators which are capable of producing drive gases over a wide range of pressures and temperatures. By modifying traditional gas turbines to operate with a steam/CO2 drive gas-rather than an air-based drive gas they have no need for the air compressors or combustors that are essential components of conventional turbines.

### A Recent Modification to the Art is Defined for Teaching Purposes:

The sum of the embodiments, overlayed with the power generation system of the State of the Art is in FIG. 12. Embodiments one through four are shown in the hull of oceanic structure 10B, with Embodiment five show as an extension 10C in the shaded area. Said extension 10C may be separate vessel or structure.

Seawater is collected in the water column using an initial filter system 75 which is pumped to Seawater Filtration Module 77. This supplies water to the HRSG Module 89 and the ITSE Module 83.

The combusted gas (flue gas) generated in the driver or power section 22 of the State of the Art is sent to a carbon dioxide separation station 25 wherein the carbon dioxide is separated from the flue gas by absorption, adsorption, membrane gas separation, or other methods well known to those skilled in the art. The carbon dioxide only is then sent to the ITSE Module 83. The non-carbon dioxide gas is sent to the HRSG Module 79, where a heat exchange takes place, converting the feed water into Intermediate Temperature Steam which is supplied to the Intermediate Temperature Steam Electrolyzer 83.

Onboard Power Generation Module 24 supplies the AC/DC converter Module 85 which in turn supplies DC power to the ITSE 83.

ITSE 83 produces syngas feedstocks which are stored in 87 and 88 for supply to the Fischer-Tropsch Module 90 and Product Upgrading Module 92. Produced liquids and gas are transferred from Module 92 to storage units 93 through 96 for offloading. Module 91 is steam a regeneration unit or alternative.

Fuel cells, hydrogen 98 or electric 99 are illustrated on deck for offloading.

It is further contemplated there could be combination of fuel cells fueled by Hydrogen, DC Power similar to transportation on land based vehicles, which are well known to those skilled in the art. Delivery of said fuel cells from the offshore structure may include drone delivery direct to residential homes or small business.

It is yet further contemplated there could be combination of gas and steam turbines fueled by hydrogen, similar to natural gas configurations on land based combined cycle power stations which are well known to those skilled in the art.

It is also further contemplated that the system could also include a separate vessel or structure having hydrogen storage capabilities and or hydrogen fuel cells.

A final contemplation, Substation 30 includes a ACDC converter station with DC power being transmitted via HVDC electric power transmission line 32 to a remote location. Where there are multiple offshore power generator systems operated by the same operator, they can be connected by an offshore DC super grid to regulate the supply to multiple coastal cities, working in partnership with RTO grid operators, governments, consumers to maximize benefit to all. End.

Limitations: Both State of the Art and Modification use a post combustion carbon capture system but the CO2 within the flue gas has a relatively low partial pressure and requires powerful separation processes, typically through absorption with aqueous amine solvents, increasing the process energy requirements, thus reducing overall power output, and limiting saleable electricity. This type of post combustion capture technology presents a costly solution to CO2 capture.

### Inventive Step: Combination or Collocation.

It is taught that consideration is needed when an invention may be to a combination or a collocation. The first step is to decide whether you are dealing with one invention or two or more inventions. If two integers interact upon each other, if there is synergy between them, they constitute a single invention having a combined effect as portrayed by using The State of the Arts as an example:

### State of the Art, Invention/Integer 1

[Thermal] Electric Power Generation System, comprising
Floating Offshore Structure or fixed Semi-permanent Structure,
Fuel source options: GAS, LNG, Coal, Oil, Heating Oil, other Hydrocarbon
Liquids & Wastepaper Products,
Gas Storage Tank, Gas Processing Module & Gas Optimization Module or LNG
Storage Tank, Regasification Module, GAS Processing Module & GAS Optimization Module or
LNG Storage Tank, GAS Processing Module and GAS Optimization Module, Power Generation Module (PGM), Substation with switching, protection, control equipment, and transformers, Subsea Power Cable,
Turret disconnect for Fuel and Subsea Power Export, and
Vessel or structure having electric power storage capabilities

### State of the Art, Invention/Integer 2

Post Combustion Carbon Dioxide Sequestration using the Oceanic Carbon Cycle, comprising Carbon Dioxide Capture and Separation Station, a System for adding chemical additives, Compression Station to compress Carbon Dioxide and transfer via Conduit to a subsea location 3 km or greater below the ocean surface.

Integer 1 and Integer 2 are interrelated but independent, however when combined they provide the solution of delivering base load power generation from a carbon neutral electric power generation facility, employing fossil fuels.

### Modification, Invention/Integer 3.

A Carbon Dioxide Upgrading System, comprising said Post Combustion Carbon Dioxide Capture and Separation Station, Seawater filtration system, AC/DC convertor system, Sequestration System with a Heat Recovery Steam Generator, an Intermediate Temperature Steam Electrolyzer, H2 & CO Storage, Production System incorporating a Fischer-Tropsch Synthesis process, Product Upgrading system, Storage and offloading system, and a Steam Regeneration system connected to a Steam Turbine and Generator.

Integer 1 & Integer 3 are interrelated but independent, however when combined they provide a solution to Transmission Losses from remote base load power stations by removing the requirement for proximity to deep water, and relocation to proximity of high demand coastal load centers. The said carbon dioxide upgrading system is a value add, instead of value negative (cost).

Herein Integer 4: A Prime Mover System (PMS), comprising combustion of a blend of organic compounds with pure oxygen. This combination results in flue gas emissions primarily of CO2 and Water Vapor. The method of the solution is Direct Firing (DF) and Progressive Firing (DPF) using a Repurposed Heat Recovery Steam Generator (RHRSG), comprising a Forced Draft Fan circulating a supply of pure oxygen to a combustor located in a furnace zone, which is supplied with preheated blended organic compounds. A secondary firing system is used for progressive combustion. An insitu primary mist cooling system is supplied with cogeneration steam to reduce flame temperature.

Said RHRSG supplies High, Intermediate, and Low Pressure steam for Steam Turbine and Cogeneration i.e., High Temperature Steam Electrolysis for Oxygen and Hydrogen, therein supplemental feedstock and method of the PMS.

PMS Auxiliary Equipment comprises an AC/DC Convertor Module and a Cryogenic Air Separation Unit (ASU) for supply of pure oxygen to said RHRSG.

The elements identified are the exceptions to a standard HRSG, which comes typically equipped with an SCR system, designed to reduce the NOx emissions and main elements such as: Superheaters, Evaporators, Economizers, Steam Drum, Deaerator, and Steam Recycle and Reheat Systems. For clarification, the system of said RHRSG is repurposed for direct firing combustion of organic compounds; this is not Flue Gas Recycling, nor Super Critical CO2 working fluids, nor an adaption of Allam-Fetvedt Cycle nor bespoke oxy-fuel turbines, such as turboexpanders that have no need for air compressors or combustors; the essential components of systems herein.

Herein Integer 5: Comprising a Combustion Byproduct Upgrading System (CBUS). The PMS byproduct is flue gas with high concentrations of CO2 and water vapor with potential for trace amounts of SO2, NOX and other particulates. The CBUS comprises an ITSE for co-electrolysis of said CO2 and Water Vapor, into H2 and CO, known as Syngas. Said trace gases will have detrimental effects in the ITSE, so they are separated when they exit the RHRSG, using Membrane Separation Technology. Said CBUS is inclusive of the CO2 upgrading system, comprising a Syngas/Product Upgrading system, a Production System incorporating a Fischer-Tropsch Synthesis process, plus Storage and Offloading.

### Inventive Step, Collocations

It is further taught that two features interact synergistically if their functions are interrelated and lead to an additional effect that goes beyond the sum of the effects of each feature taken in isolation. It is not enough that the features solve the same technical problem or that their effects are of the same kind and add up to an increased but otherwise unchanged effect.

Integer 4 & Integer 5 are interrelated but independent, when combined they are a climate neutral, prime mover system.

An unforeseen advantage is said Oceanic Structure may now be located in close proximity to onshore using permanent moorings as the industrial process will be in compliance with future State and County air pollution regulations

Another unforeseen advancement is the new location enables connection to distribution networks as embedded or distributed generation, providing Security of Supply, and reducing installation costs and transmission use of system charges.

The Combination of Integer 4 and Integer 5 can be compared to a transmitter and receiver which work only together which is characterized in additional independent claims. As a prudent operator, the use of organic compounds for prime movers (Integer 4) dictates a sequestration system (Integer 5) and they work, only together, to accomplish said climate neutrality.

Responsibility for adoption should lie with generation operators, and not the government, who have many other crises to administer and wars to mitigate.

### Inventive Step, Obvious

Would this inventive concept been obvious, at the time of filing this application to someone skilled in the art, tasked with solving said ‘New Problem’ of a potential failure of ECO Barriers with Loss of Containment (LoC), and an abrupt natural release of Green House Gases (GHG).

Why, would someone skilled in the art select a floating offshore, base load, power generation solution as it is common industry knowledge to be a cost prohibitive exercise to locate a large-scale thermal power station, at an offshore location, notwithstanding the challenges of emissions sequestration to achieve climate neutrality and social acceptance thereof. Criteria at the time of filing would dictate onshore gas fired, power generation to sustain competitive dispatch in wholesale markets with no carbon tac and offset with investments in renewable projects both onshore and offshore and green marketing campaigns to pull the wool over the eyes of the flock. Their motivation is pure financial reward, as they are in the business of making money, lots of it, and thereof not social enterprises. Which ends up with the elderly of society paying a premium for said green energy and have to choose between eating and heating, or cooling dependent on location.

My motivation is to mitigate the worst case scenario, and improve the standard of living for all, and not simply investment criteria as per others in the art.

Energy is a necessity for everyday living, and to deliver the solution to climate change will require an Energy without Boarders' philosophy and sharing of technology, similar to a medial vaccine in a pandemic, wherein the quicker it is administered the less people will die, herein due to extreme weather events.

### Inventive Step: Novelty

The fact is there was no real explanation why this combined inventive concept was not taken up well before now. The simplest explanation, indeed, the only one that fits the known facts is the inventors hit upon something which others had missed when working backwards on a solution to mitigate climate change risk.

This is collaborated by an unforeseen advantage, relocation from offshore to onshore, replacing the oceanic structure with a land based equivalent, key modules would be similar. This in turn could be the ‘holy grail’ solution to mitigate the adverse effects of climate change, whist retaining the fossil fueled energy markets of our technology world and the comparative advantages of nations. To which, if the inventive concept were obvious it would have already be implemented.

### What is the Inventive Step/Solution?

So, my inventive step is the way of solving the ‘New Problem’ and my inventive step is that solution, renamed post discovery of unforeseen advantages: Climate Neutral Generation System, (CNG) i.e., ‘CNG Offshore’ or ‘CNG Onshore’.

### SUMMARY OF THE INVENTION

The invention is as defined in the claims.

### BRIEF DESCRIPTION OF THE DRAWINGS

These and further features and advantages of the present invention will become apparent from the following detailed description, wherein reference is made to the figures in the accompanying drawings.

FIG. 1 through to FIG. 7 are for teaching of a potential worst case risk scenario associated with Climate Change.

FIG. 8 through to FIG. 10 are for teaching the current State of the Art, where FIG. 11 teaches of a simplified schematic view of a typical gas turbine system that can be employed in the system and method of said State of the Art invention.

FIG. 12 is a simplified schematic view of cumulative embodiments of a modification integrated with the base load generation system of said State of the Art.

FIG. 13 is a simplified schematic view of the present invention, therein the climate neutral prime mover and generation system, employed for the system and method.

FIG. 14 is similar to FIG. 13 showing another embodiment of the present invention

FIG. 15 is similar to FIG. 14 showing another embodiment of the present invention

FIG. 16 is a cumulative schematic view of embodiments FIG. 13, FIG. 14 & FIG. 15

FIG. 17 is a simplified schematic view of embodiments of the present invention integrated with the offshore structure and auxiliary systems of said State of the Art.

FIG. 18. is a simplified schematic view of a embodiment of the present invention with an onshore structure and offshore auxiliary system of said State of the Art.

FIG. 19. is a simplified schematic view of another embodiment of the present invention with an onshore structure, product upgrading system and DC distribution and the offshore auxiliary system of said State of the Art.

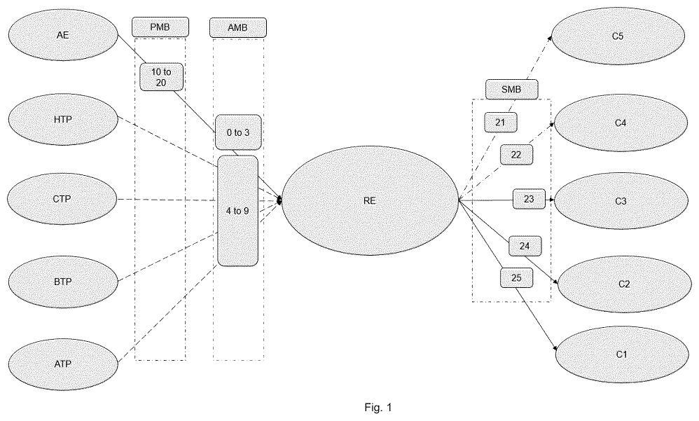

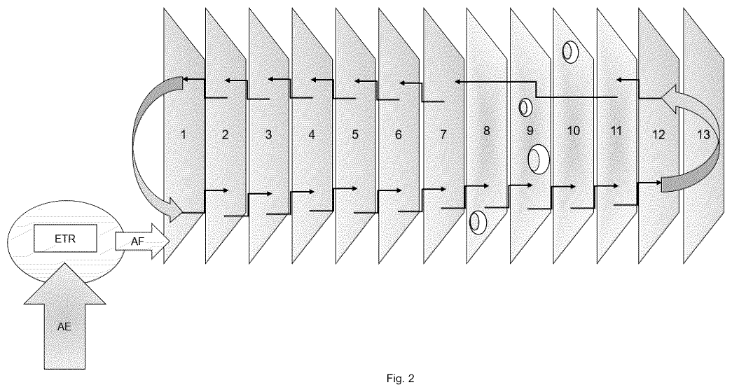

### DETAILED DESCRIPTION OF PREFERRED EMBODIMENTS

For 2022 AD, about 4,231 billion kilowatt-hours (kWh) (or about 4.23 trillion kWh) of electricity were generated at utility-scale electricity generation facilities in the United States. About 60% of this electricity generation was from fossil fuels: coal, natural gas, petroleum, and other gases, to which necessitated a Prime Mover and associated anthropogenic emissions. Other industries use steam and heat for conversion of raw materials, such as blast furnaces for steel production and rotary kilns; a large process unit used in cement production where limestone is decomposed into calcium oxide which forms the basis of cement under high temperatures. Furthermore, marine propulsion also necessities a prime mover system. Notwithstanding the use of prime movers for power generation, historically approximately 37% of fossil fuels combustion was to produce industrial steam.

The present invention is a modification of elements of said State of the Art, namely Driver or power section 22, of module 20 (power generation module and gas collection system comprised of a compression station 26 to compress the flue gas and transfer it to a conduit or line 28 to a subsea location at a desired optimal depth. In a preferred embodiment, prior to compression in compression station 26, the flue gas is sent to a carbon dioxide separation station 25 wherein the carbon dioxide is separated from the flue gas by absorption, adsorption, membrane gas separation. Said State of the Art Elements are superseded by a Prime Mover System (PMS), and a Combustion Byproduct Upgrading System (CBUS), and when combined they create a ‘Climate Neutral’ process.

The Embodiments of the invention are described more fully hereafter with reference to the accompanying drawings. Elements that are identified using the same or similar reference characters refer to the same or similar elements.

The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art. The foundation of said climate neutral prime mover system is the combustion process of blended organic compounds with pure oxygen, herein the apparatus and method of the present invention are designed to achieve this.

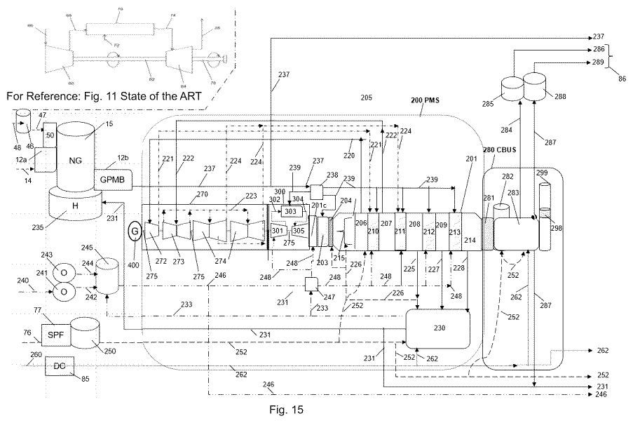

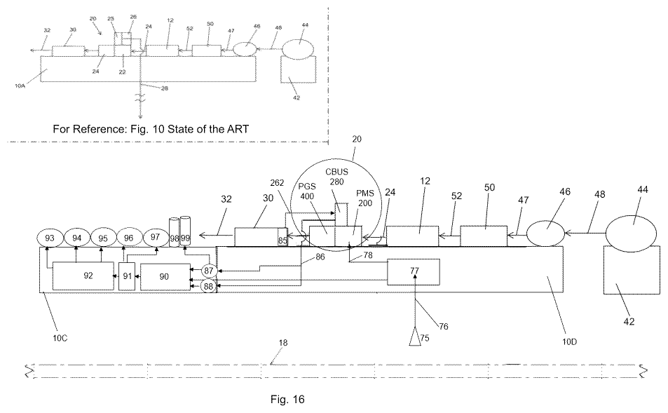

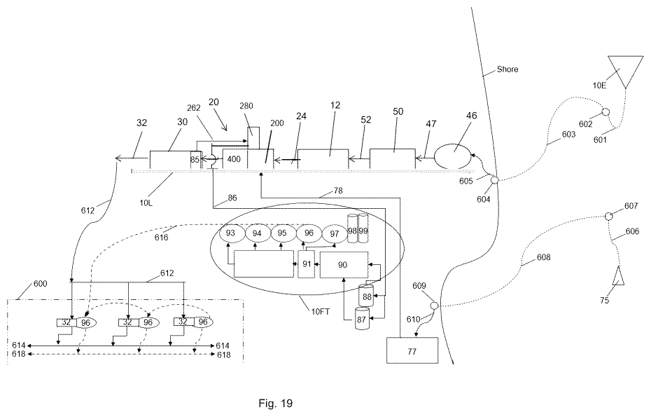

There are seven embodiments described for the present invention, each with a schematic drawing with a sequential buildup to a distribution system for DC power and liquid, gas fuel products produced in a climate neutral process. The embodiment illustrated is to support security of supply for the transportation sector, namely electric and diesel engines with a low carbon transitional fuel product to sustain the transportation of heavy good vehicles, i.e., HGVs. The cumulative system schematic with integration on the offshore structure of said State of the Art, is shown in FIG. 16, and for an onshore structure in FIG. 19.

The first embodiment for the PMS is Direct and Progressive Firing integrated with said CBUS, shown in a corresponding schematic in FIG. 13. To confirm what is new in the present invention the gas turbine schematic for the power generation module of “The State of the Art”, FIG. 4, is shown at top left corner.

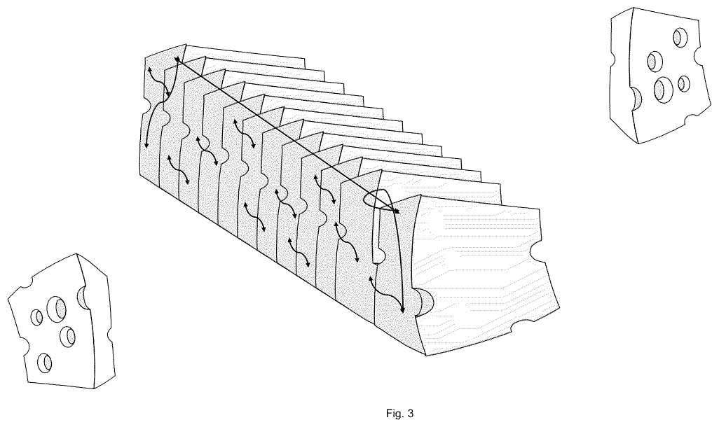

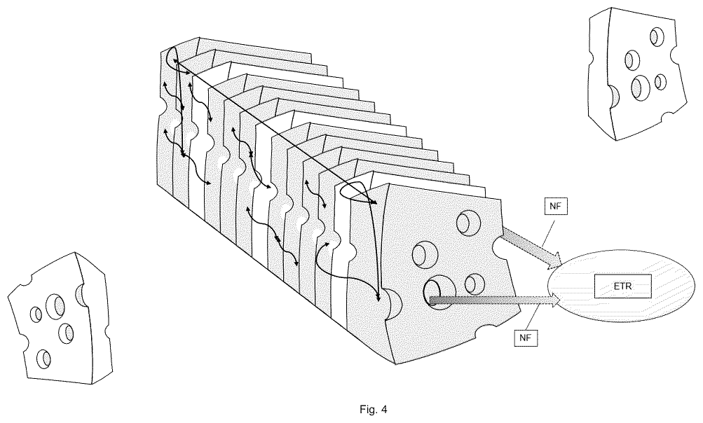

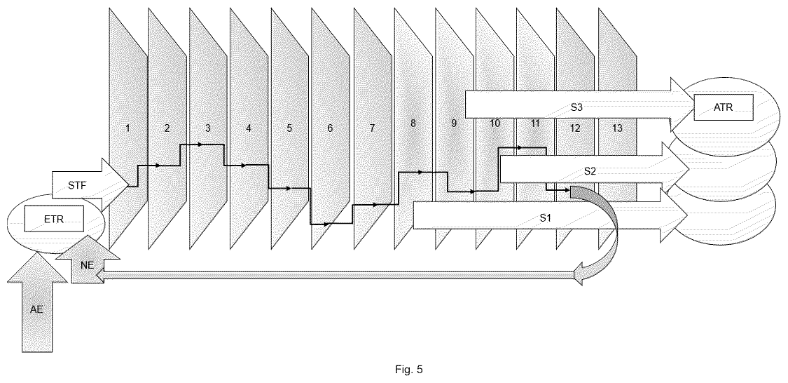

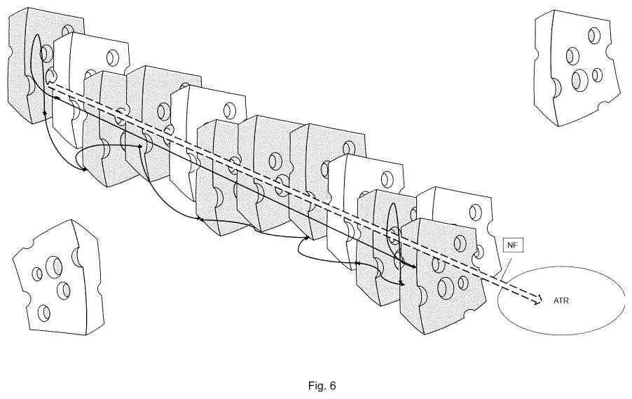

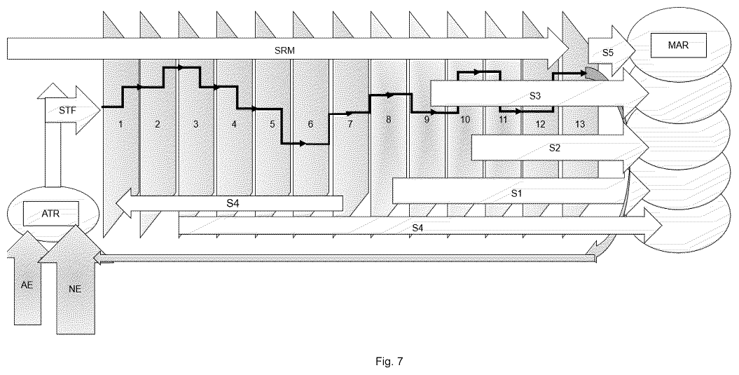

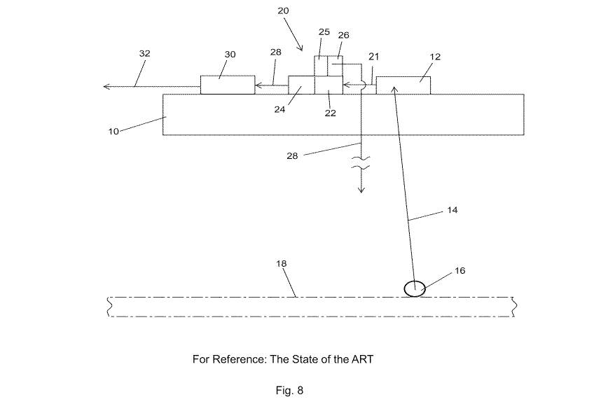

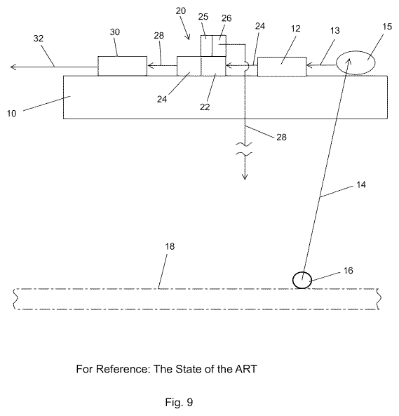

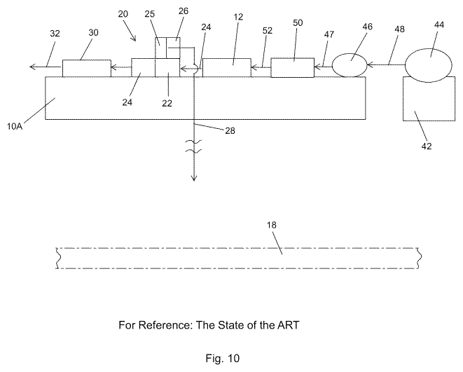

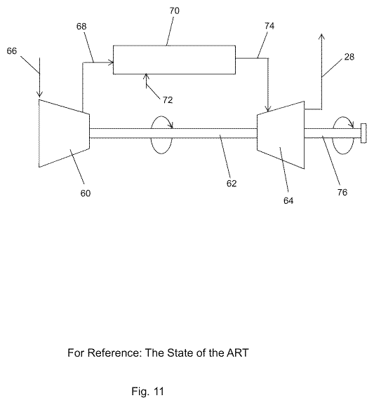

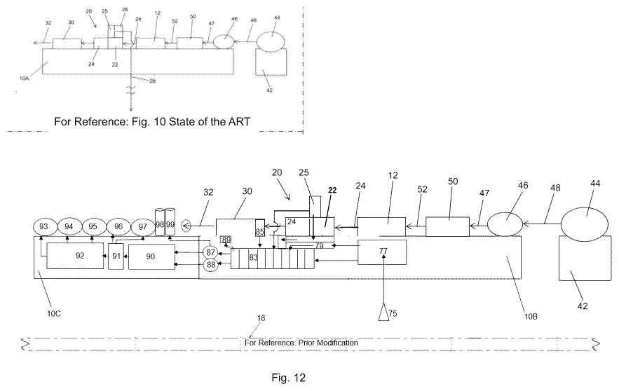

An outline is shown on the schematic encompassing the individual elements of said climate neutral system, 200 for the PMS and 280 for the CBUS80. The system of the present invention begins with the supply of raw feedstock for conversion to heat energy. Organic compounds flow to the conversion apparatus, RHRSG 201 via a subsea pipeline 16 connected to a subsea riser system 14, shown in the State of the Art FIG. 8. Said riser is connected via line 14 to a Gas Processing Module 12, which has been modified for the present invention to include a Acid Gas Removal System and renamed 12a, which supplies the adjacent Storage Tank 15. An alternative method is organic compound delivery by a barge or tanker ship 41 with temperature-controlled tanks 44, as shown in FIG. 10, the liquified organic compounds are transferred from tank compartment 44 via line 48 to storage vessels 46 on structure 10D, for the present invention. liquified organic compounds are transferred via line 47 to a regasification module 50 and thereafter regasified organic compounds are stored in storage tank 15.

Using fuel injection technology, it may be possible for liquified organic compounds to be used for combustion in the PMS, without regasification.

A Hydrogen Storage Tank 235 is connected to Gas Processing Module for Blending (GPMB) 12b with feedstock from Organic Compound Storage Tank 15. Blended Organic Compounds (BOCs) are then supplied via line 237 to a Preheater 238 and via line 239 to the RHRSG Direct Firing System 203 and the RHRSG Progressive Firing Systems 210, 211, 212, 213 and a supply line 237 to next cycle.

Liquified Pure Oxygen (LPO) is supplied via line 140 to the liquid oxygen converter 241 and transferred via line 242 to the Oxygen Storage Tank (OST) 245.

An onboard Air Separation Unit (ASU), 243 uses a Cryogenic process to separate oxygen from air. The process can produce high purity oxygen but is well known to be energy intensive. Said ASU supplies OST 245 via line 244.

The OST supplies pure oxygen via line 246 to preheater 247, which supplies pure oxygen via line 248 to the RHRSG Forced Draft Fan System (FDFS) 201a, and via line 248 to RHRSG Progressive Firing Systems 210, 211, 212, 213, and a supply line 246 to next cycle.

The purpose of Said RHRSG FDFS 201a, is to facilitate oxygen throughput in the combustion furnace 205 to avoid damaging equipment, which is supported by a Forced Cooling System (FCS) 204, 215 supplied by cogeneration steam 226.

A Seawater Filtration Plant (SFP) 77 similar to a desalination system, is used to remove containments from seawater that could impact the onboard conversion of feedstock to energy products The SFP has a pumping system which draws seawater from the water column 75 via line 76 (Illustrated in FIG. 16.). Desalinated water is stored in tank 250 which is supplied via line 252 to the onboard conversion apparatus RHRSG 201, HTSE 230 and ITSE 283.

The onboard essential supplies' distribution board supplies AC power via line 260 to AC/DC converter station 85, which supplies DC power for the system and method of electrolysis via line 262 to HTSE 230, ITSE 283 and the next cycle.

The RHRSG supplies High Pressure (HP) and Intermediate Pressure (IP) Steam via lines 220 and 222 to the Steam Turbine (ST) System 270: therein ST HP 272 and ST IP 473 respectively with reheat cycles to the RHRSG shown via lines 221, 223 and 224 respectively.

Said Steam Turbine System (STS) converts heat energy in the steam to mechanical/kinetic energy to rotate shaft 275 which is connected to power generation system (PGS) 400, producing base load energy for onward distribution.

The objective of the combustion process is to achieve complete burnout for the blend of organic compounds. A method employed for the present invention is combustion using fuel biasing, by diverting fuel in said direct and progressive firing systems 203, 210, 211, 212 and 213, from upper level burners to lower level burners, or from center burners to side burners, or multiple variations thereof. This method lowers the flame temperature and improves the balance of oxygen concentration in said combustion chamber 205, the area of the RHRSG furnace where fuel and oxygen mix. To teach, the combustion chamber is the part of the furnace where organic compounds are burnt with pure oxygen to create the heat that enters into the RHRSG heat exchangers, which convert desalinated water to High Pressure steam 206, Intermediate Pressure steam 207, 208 and Low Pressure steam 209 and 214. This is used to supply steam turbine system 270, and for onboard cogeneration demand, High Temperature Steam Electrolysis (HTSE) 230, to produce Oxygen and Hydrogen products, the method of the PMS.

Said produced Hydrogen is transferred via line 231 to onboard Hydrogen Storage Tank 235 and via line 231 to the next cycle.

Said produced Oxygen is transferred via line 233 to onboard PO storage 245 and via line 233 to the oxygen preheater 247, for supply to direct firing and progressive firing system or to the next cycle via line 246.

The sequestration system for the present invention, said CBUS 280, comprises Membrane Separation Technology (MST) 281 for separating trace gases in the flue gas. Said MST 281 is connected to the RHRSG Exhaust and to the Electrolyzer 283 which uses Intermediate Temperature Steam Electrolysis (ITSE) to split said combustion byproducts of CO2 and water vapor, by a process well known to those skilled in the art. The co-electrolysis produces feedstocks of Carbon monoxide (CO), output is via line 284 to CO feedstock storage system 285 and Hydrogen (H2) output is via line 287 to H2 feedstock storage system 288 or to next cycle via line 287, connected to line 237 and connected to tank 235.

The flue gas stack 299 incorporates monitoring equipment 298 to ensure the composition does not contain Green House Gas Constituents. The DCS will monitor the flue gas composition and recalibrate said fuel biasing to optimize operational efficiency, i.e. Burnout. If flue gas monitoring shows detection of trace nitrogen gases, NOx, dictates a leak and air ingress to the closed RHRSG system.

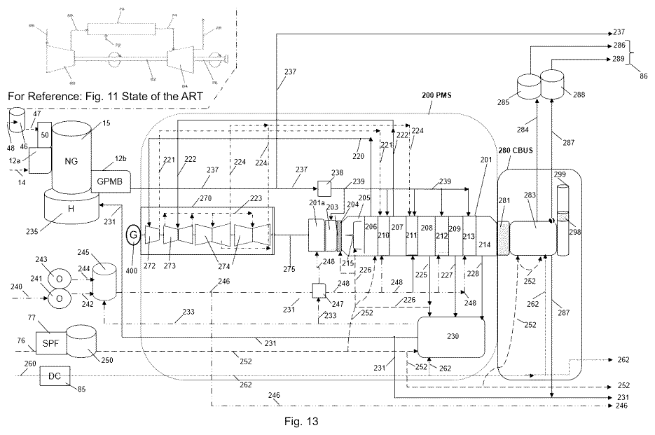

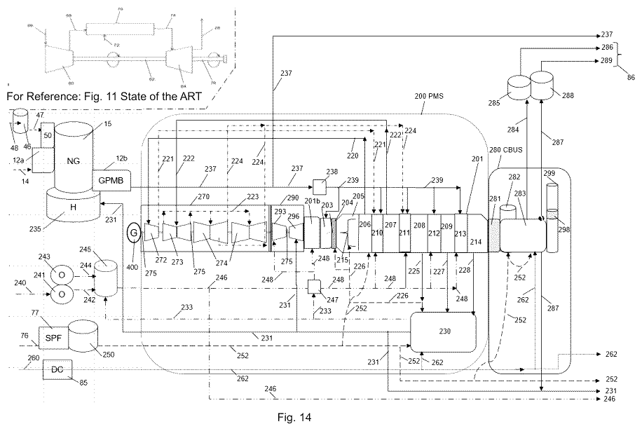

The second embodiment of the system and method of the present invention, shown in FIG. 14, comprising addition of a Supplementary Firing System (SFS) 290.

A Compressor 293 is supplied with preheated pure oxygen via line 248 and a Combustion Turbine (CT) 296 is supplied with processed hydrogen via line 231 from HTSE 230. The exhaust of said CT is connected to a suitably modified RHRSG Forced Draft Fan System (FDFS) and shown as 201b. The Sequestration System CBUS 280 includes backpressure management with a Condenser 282.

When the flue gas water vapor is cooled and condensed, it consumes a vastly lower volume and thus lowers the pressure or creates a vacuum. This lower pressure in turn increases the differential pressure across the combustion turbine stage and improves efficiency, due to vacuum in the condenser. Said vacuum sucks the water vapor from exhaust and lowers the back pressure. If an elevated back pressure is desirable for process usage, the degree of cooling needs to be controlled to manage the back pressure. The function of the ITSE will assist the process the condenser is utilized as a supplemental system to offer more control.

Compressor 293 and CT 296 are connected to the shaft of STS 275 which is connected to PGS 400, producing said base load energy for onward distribution.

The method of the present invention is for supplementary firing as the RHRSG requires to be at full load, supplying cogeneration steam to said HTSE, to produce said hydrogen, for said supplementary firing.

The third embodiment, shown in FIG. 15, comprises the addition of an Auxiliary Firing System (AFS) 300. The elements and layout of the AFS are similar to a typical gas turbine system that can be used in the power generating system of the present invention. The AFS 300 comprises a compressor 301, coupled by shaft 275 to a turbine 305. In a well-known manner, preheated pure oxygen is introduced into compressor 301 via line 248, the preheated pure oxygen being compressed and then transferred via line 302 to a combustion chamber 303 where it is admixed with a suitable blended organic compound i.e., preheated blended hydrogen via line 304, the fuel igniting in combustion chamber 303 to generate a high temperature, high pressure gas flow which is introduced via line 304 into a Ultra-High Temperature Combustion Turbine (UHTCT) 305 to drive said UHTCT 305 wherein it expands down to an exhaust pressure producing a shaft work output via shaft 275 which can then drive said PGS 400. The exhaust gases from said UHTCT are connected to a suitably modified RHRSG Forced Draft Fan System (FDFS) and shown as 201c. The embodiment is for auxiliary firing as operation of the RHRSG is needed to supply cogeneration steam to said HTSE, to produce said hydrogen, for said preheated blended hydrogen supplied via line 304.

The forth embodiment, shown in FIG. 16, comprises the power station module 20 inclusive of Climate Neutral Elements, PMS 200, and CBUS 280. The modified Oceanic Structure is renamed 10D, and it is noted extension 10C may be separate vessel or structure, for safety or operational reasons.

Seawater is collected in the water column using an initial filter system 75 which is pumped to Seawater Filtration Module 77. This supplies water to the elements of the PMS 200 and the elements of the CBUS 280.

An electric power substation 30 supplies the AC/DC converter Module 85 which supplies DC power via line 262 to the DC process loads of PMS and CBUS.

Syngas feedstocks are exported via combined line 86 to structure 10C storage tanks 87 and 88 which supplies the Fischer-Tropsch Module 90 and Product Upgrading Module 92. Produced liquids and gas are transferred from Module 92 to storage units 93 through 96 for offloading. Steam Regeneration 91 with fuel cells, hydrogen 98 or electric 99 are illustrated on deck for offloading.

The fifth embodiment, shown in FIG. 17, comprises the power station module 20 inclusive of Climate Neutral Elements, PMS 200, and CBUS 280. The modified Oceanic Structure 10D is shown with an alternative organic compounds delivery system via a submerged turret mooring and offloading (STL) system 10E.

A buoy is moored to the seabed 18, and this is pulled into, and secured to, the turret mating cone in the ship bottom. A swivel in the turret allows the ship to weathervane without the aid of propulsion.

Said delivery tanker may be of the new type of liquefied organic compound tanker provided with re-gasification facilities. A tanker having loaded a liquefied organic compound cargo in the conventional way regasifies the cargo on board and discharges the high-pressure gas at an offshore buoy or floating terminal.

The PGS 400 of Power Station Module 20, may include DC generators which supply DC inverter 555 located in Substation Module 30. Export line 501 delivers the DC power to a remote location on land 500 for use at a transportation refueling service center. Different grades of DC power 502 are supplied suitable for the different vehicle battery systems, light duty 556, long range 557 and heavy good vehicles 558. This will enable faster charging systems and security of supply during grid interruptions. DC underground line 504, supplies the next location.

To enable the transition to low carbon fuels for the Industrial Transportation Sector, a hybrid fuel, combining hydrogen and diesel produced by the processes defined in elements 90 and 92 herein named HD. For a viable product and to fulfill a need, said product characteristics are deemed as liquid fuel to supply diesel transportation, with minimal engine or exhaust modifications. The product HD is defined by the process of the Fischer-Tropsch Synthesis Module 90, with an output of synthetic crude which is transferred, to Product Upgrading System Module, 92 wherein said synthetic crude is further processed supplying said HD, aviation fuels, transportation fuels and feedstocks; i.e., Base Oils, Gas Oil, Kerosene, Paraffins, Naphtha or the gaseous products of Condensate, LPG and Ethane. A subsea export line 503 transfers said HD a remote location on land 500 for use at a transportation refueling service center, shown at 96 and via line 505.

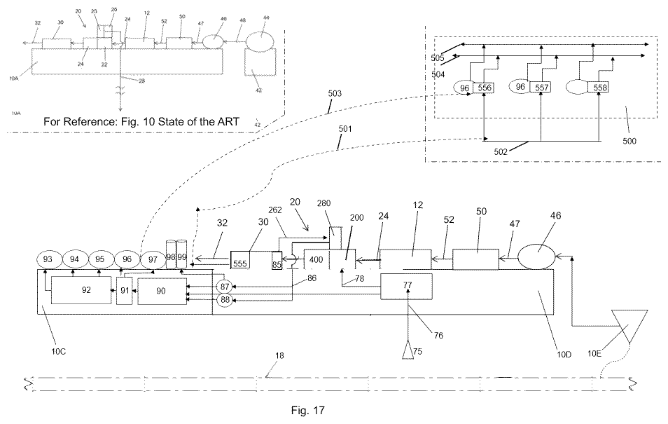

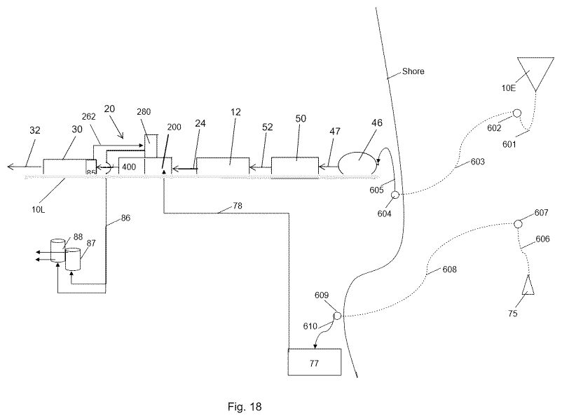

The sixth embodiment, shown in FIG. 18, comprises a new structure 10L which is located onshore incorporating all the elements of oceanic structure 10D.

An organic compounds delivery system is shown via a submerged turret mooring and offloading (STL) system, 10E connected to a subsea pipeline 602, via line 601. The pipeline end termination unit 604 supplies a onshore pipeline 605 to the organic compound storage tank 46, located on structure 10L.

Seawater is collected in the water column using an initial filter system 75 which is pumped onshore via lines 606, 607, 608, 609 and 610 to Seawater Filtration Module 77. This supplies desalinated water, via line 78 to the elements of the PMS 200 and the elements of the CBUS 280.

Syngas Feedstock is supplied to a remote land location via combined pipeline 86, to storage tanks 87 and 88 respectively.

The system and method of the elements shown on 10L cumulatively provide a dispatchable, climate neutral base load power generation system.

The seventh embodiment, shown in FIG. 19, comprises the cumulation of all the embodiments shown in FIG. 13 through to FIG. 18. Functionally is the same location of DC Grid is shown as 600 and the byproduct upgrading system is relocated from 10C to onshore. The system and method of the elements shown on 10L cumulatively provide a dispatchable, climate neutral base load power generation system. The system and method of elements 10 FT cumulatively provide said HD, aviation fuels, transportation fuels from a climate neutral process.

To enable base load operation in the event of a distribution or transmission network failure, the system retains a separate vessel or structure having electric power storage capabilities and or a separate vessel or structure having hydrogen storage capabilities. It is contemplated that further to an extreme weather event affecting onshore security of supply, said vessels with energy storage capabilities can transferred to another location to supply energy products.

Although specific and cumulative embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations, and modifications, including but not limited to those design alternatives specifically discussed herein, may be made in the practice of the invention without departing from its scope.

What is claimed is:

1. A system suitable for a climate neutral conversion of organic compounds to drive a power generation prime mover, comprising:
a Steam Conversion System suitable for steam generation with a flue gas composition consisting essentially of a CO2 gas and a Water Vapor gas with the balance potential for trace amounts of a SO2 gas, a NOx gas and particulates;
a first Steam Output for said Steam Conversion System connected to a first Steam Electrolyzer System, said first Steam Electrolyzer System being suitable for steam conversion to Hydrogen gas and Oxygen gas for recirculation;
an exhaust from said Steam Conversion System connected to a Membrane Separation Technology System, said Membrane Separation Technology System being suitable for separation of said flue gas consisting essentially of said SO2 gas, NOx gas and other particulates from said CO2 gas and Water Vapor;
an exhaust from said Membrane Separation Technology System is connected to a second Steam Electrolyzer System that is suitable for said CO2 gas and Water Vapor conversion to a Carbon Monoxide and a Hydrogen output;
a second Steam Output for said Steam Conversion System is connected to a Steam Turbine System, therein being a prime mover system converting heat energy from steam into mechanical/kinetic energy to rotate a turbine shaft; and
a flue gas stack integrated with a Monitoring System is connected to an exhaust output of said second Steam Electrolyzer System, said Monitoring System is connected to a Steam Conversion System's Distributed Control System (DCS) which is suitable for control of and monitoring for Green House Gas Constituents.

2. A method of operating the system of claim 1, wherein using one fuel source for three or more energy conversions, comprising:
providing a flow of organic compounds and oxygen to the Steam Conversion System for a conversion to Heat Energy and a flue gas composition consisting essentially of a CO2 gas and a Water Vapor gas with the balance potential for trace amounts of a SO2 gas, a NOx gas and particulates;
providing a flow of H2O to said Steam Conversion System for a conversion of said Heat Energy to Steam Energy;
providing a flow of said Steam Energy from the first steam output for said Steam Conversion System to the first Steam Electrolyzer System for conversion of said Steam Energy to said Hydrogen gas and said Oxygen gas for recirculation;
providing a flow of flue gas from the exhaust of said steam conversion systems to said Membrane Separation Technology System, which thereby separates said CO2 and Water Vapor from said SO2, NOx and other particulates;
providing a flow from the Membrane Separation Technology System to the second Steam Electrolyzer System of said CO2 and Water Vapor for a conversion to said Carbon Monoxide and Hydrogen;
providing a flow of Steam Energy from the second steam output of said Steam Conversion System to a Steam Turbine System wherein said Steam Energy is converted to mechanical/kinetic energy to rotate said turbine shaft; and
providing a flow of flue gas from an exhaust of the second Steam Electrolyzer System to a flue stack, containing an integrated Monitoring System, said Monitoring System being connected to a Steam Conversion System's DCS which is suitable for control of and monitoring for Green House Gas Constituents.

3. The system of claim 1, wherein the rotating output turbine shaft of said Steam Turbine System is connected to a Power Generation System, wherein said Power Generation System is suitable for AC or DC generation with an export connection to a power grid for delivery of said AC power and or to an DC microgrid for transportation systems, said Power Generation System is furthermore suitable for connection to an AC distribution network as embedded generation.

4. The system of claim 3, wherein said system is connected to a separate vessel or a structure having electric power storage capabilities and/or a separate vessel or a structure having hydrogen storage capabilities, and/or the system is connected to a combination of fuel cells and batteries for supply of said Hydrogen and or DC Power similar to transportation on land based vehicles, whereby delivery of said fuel cells may include drone delivery direct to residential homes or small business.

5. A method of generating power with the system of claim 1, comprising:
providing said system, wherein said system is a prime mover for power generation, therein enabling climate neutral power generation and security of supply for base load operation.

6. The system of claim 1, wherein said second Steam Electrolyzer System's output is upgraded, comprising:
an output from the second Steam Electrolyzer System is connected to a Production System for supply of said Carbon Monoxide and Hydrogen, wherein a Fischer-Tropsch Synthesis Module converts said Carbon Monoxide and Hydrogen to synthetic crude; and
the output from said Production System is connected to a Product Upgrading System for supply of said synthetic crude, the Product Upgrading System is suitable for conversion to said synthetic crude to a supply of aviation fuels, a supply of transportation fuels, and/or a supply of feedstocks.

7. The system of claim 6, wherein said Product Upgrading System is suitable to produce a hybrid fuel, blending a hydrogen supply with a diesel supply, therein a fuel product named “Hydro Diesel” (HD); and
an output from said Product Upgrading System for said HD is connected to a pipeline for supply.

8. The system of claim 1 wherein said system is suitable for location either offshore or onshore.

9. A method of supply steam with the system of claim 1, comprising:
generating steam in a climate neutral conversion and providing said steam to other industrial processes.

10. A system suitable of steam conversion for a flue gas composition consisting essentially of a CO2 gas and a Water Vapor gas with the balance potential for trace amounts of a SO2 gas, a NOx gas and particulates, comprising:
a Combustion Chamber;
a Fan System integrated with said Combustion Chamber, wherein said Fan system is connected to a supply of Oxygen, said Fan System being suitable for facilitating oxygen throughput in said combustion chamber;
a cooling system integrated between said combustion chamber and a Steam Conversion Apparatus, wherein said Steam Conversion Apparatus is suitable for conversion of heat energy to steam energy;
a plurality of firing systems connected to a supply of organic compounds, wherein said firing systems are integrated within said Combustion Chamber and said Steam Conversion Apparatus; and
the firing systems are connected electrically to a Fuel Biasing System which is suitable for adjusting the flame temperature to improve the balance of oxygen concentration in said combustion chamber.

11. The system of claim 10 connected to a secondary combustion system, suitable for combustion of recirculated Oxygen and Hydrogen, comprising:
a turbine shaft;
a Compressor, suitable for compression of Oxygen, said Compressor being connected to said turbine shaft;
a Combustion Turbine connected to said turbine shaft, said Combustion Turbine is connected to said compressor to receive a supply of compressed oxygen and connected to a supply of Hydrogen gas, wherein an exhaust for said Combustion Turbine is connected to said Fan System;
the exhaust of said Steam Conversion Apparatus is connected to a condenser suitable for backpressure management;
an Oxygen input for said Compressor is connected to a first Steam Electrolyzer for supply of said Oxygen gas; and
a Hydrogen input for said Combustion Turbine is connected to the first Steam Electrolyzer for supply of said Hydrogen gas.

12. The system of claim 10 connected to an alternative secondary combustion system, comprising:
a turbine shaft;
a compressor, suitable for compression of Oxygen, the compressor being connected to said turbine shaft;
a combustion chamber suitable for combustion of organic compounds with oxygen, said combustion chamber being connected to said compressor to receive a supply of compressed oxygen and connected to a supply of organic compounds, an outlet of said combustion chamber supplies a high temperature, high pressure gas flow to a connected combustion turbine wherein it expands down to an exhaust pressure producing a turbine shaft work output;
an exhaust for said Combustion Turbine is connected to the fan system;
the exhaust of said Steam Conversion System is connected to a condenser suitable for backpressure management;
an Oxygen input for said Compressor is connected to a first Steam Electrolyzer for supply of said Oxygen gas;
a Hydrogen input for a Gas Processing Module is connected to the first Steam Electrolyzer for supply of said Hydrogen gas; and
the Gas Processing Module blends said Hydrogen with said organic compounds, wherein the outlet of said Gas Processing Module is connected to the input of said Combustion Chamber for supply of a blended organic compounds.
